(19) United States
(12) Patent Application Publication
(10) Pub. No.: US 2022/0356962 A1
(43) Pub. Date: Nov. 10, 2022

(54) STICK SLIP DETECTION SYSTEM AND METHOD

(71) Applicant: Azbil Corporation, Tokyo (JP)

(72) Inventors: Koichiro HIRAO, Tokyo (JP); Fumiaki YAMASAKI, Tokyo (JP)

(73) Assignee: Azbil Corporation, Tokyo (JP)

(21) Appl. No.: 17/723,895

(22) Filed: Apr. 19, 2022

(30) Foreign Application Priority Data
May 10, 2021 (JP) 2021-079520

(51) Int. Cl. F16K 37/00; F15B 19/00

(52) U.S. Cl. CPC F16K 37/0083; F15B 19/005; F15B 2211/87

(57) ABSTRACT

A stick slip detection system includes: an operation data storage unit configured to store a stick slip index, the stick slip index being a ratio of a first state amount based on a displacement of a valve shaft of a valve to be diagnosed to a second state amount based on the displacement; an abnormality diagnosis unit configured to determine whether a stick slip phenomenon occurs in the diagnosis target based on the stick slip index; and a diagnosis operation control unit configured to, when a stepwise change in a control command value in an intermediate opening degree of the valve to be diagnosed is detected, stop a determination operation of the abnormality diagnosis unit. The present disclosure makes it possible to easily reflect knowledge of an expert with respect to a diagnosis target such as a valve in the stick slip detection system and method.

### CROSS REFERENCE TO RELATED APPLICATIONS

This patent application claims the benefit of foreign priority to Japanese Patent Application No. JP 2021-079520 filed on May 10, 2021, the disclosure of which is hereby incorporated by reference in its entirety.

### BACKGROUND OF THE INVENTION

The present disclosure relates to a stick slip detection system and method for detecting a stick slip of a diagnosis target such as a valve, and more particularly to a technique for suppressing erroneous detection of the stick slip.

A stick slip of a valve is a phenomenon in which a stop (stick) and a slide (slip) of a valve shaft are repeated. As a method of detecting a stick slip, there is a method disclosed in PTL 1. In the method disclosed in PTL 1, an average value X of absolute values of a valve shaft speed and a square root Y of a mean square of the valve shaft speed are calculated from a displacement xᵢ of the valve shaft as shown in Equations (1) and (2) (N is the number of pieces of displacement data used to calculate state values), and a value SSpv obtained by dividing Y by X is calculated.

$$[ Equation 1 ]$$

$$X = \frac{1}{N - 1} {\sum }_{i = 1}^{N - 1} \vert {x}_{i + 1} - {x}_{i} \vert \qquad ( 1 )$$

$$Y = \sqrt{\frac{1}{N - 1} {\sum }_{i = 1}^{N - 1} {( {x}_{i + 1} - {x}_{i} )}^{2}} \qquad ( 2 )$$

SSpv has a characteristic that it increases as a stick slip phenomenon of the valve increases. In the method disclosed in PTL 1, a stick slip is determined when the stick slip index SSpv is equal to or larger than a threshold value.

However, in the method disclosed in PTL 1, even if no abnormality occurs in the valve, a behavior of the measured value of a valve shaft displacement may be similar to that of a stick slip state when a control command value itself of the valve shaft displacement greatly changes, and it may be erroneously determined that there is the stick slip state.

Therefore, a method of suppressing erroneous detection of a stick slip has been proposed (see PTL 2). In the method disclosed in PTL 2, not only with respect to a measured value of a valve shaft displacement, but also with respect to a control command value of the valve shaft displacement, the average value X of the absolute values of the valve shaft speeds and the square root Y of a mean square are calculated using Equations (1) and (2), and a value SSsp is calculated by dividing Y by X. Only when the stick slip index SSpv of the measured value of the valve shaft displacement and the stick slip index SSsp of the control command value satisfy the expression (3), it is determined whether the stick slip phenomenon has occurred, so that suppression of erroneous detection of the stick slip can be achieved.

SSpv>SSsp (3)

For the method for suppressing erroneous detection of a stick slip described above, a method has been proposed in which SSpv and SSsp are not uniformly determined, but setting parameters α and β are introduced into Expression (3) as in Expression (4) to set a range of SSpv for determination (see PTL 3).

SSpv>α·SSsp+β (4)

As described above, it is possible to set a range in which the determination is performed by the setting parameters α and β of Expression (4). However, since the stick slip indexes SSpv and SSsp are values obtained by complicated calculations, it is not easy to reflect knowledge of an expert with respect to a valve, such as excluding data from determination when a specific operation is performed, in Expression (4). Therefore, there is a demand for a method for suppressing erroneous detection of a stick slip capable of easily reflecting the knowledge of the expert.

### CITATION LIST

### Patent Literature

[PTL 1] JP-B-3254624

[PTL 2] JP-B-5571346

[PTL 3] JP-B-5824333

### BRIEF SUMMARY OF THE INVENTION

For solving the above problems, an object of the present disclosure is to provide a stick slip detection system and method capable of easily reflecting knowledge of an expert with respect to a diagnosis target such as a valve.

A stick slip detection system according to the present disclosure includes: a storage unit configured to store a stick slip index, the stick slip index being a ratio of a first state amount based on a displacement of a movable portion in a diagnosis target including the movable portion having a contact sliding portion to a second state amount based on the displacement; an abnormality diagnosis unit configured to determine whether a stick slip phenomenon occurs in the diagnosis target based on the stick slip index; and a diagnosis operation control unit configured to, when a stepwise change in a signal for controlling a position of the movable portion is detected, stop a determination operation of the abnormality diagnosis unit.

In one configuration example of the stick slip detection system according to the present disclosure, the diagnosis operation control unit stops the determination operation of the abnormality diagnosis unit when detecting a stepwise change in a control command value for controlling the position of the movable portion at an intermediate position between an upper limit position and a lower limit position of the position of the movable portion.

In one configuration example of the stick slip detection system according to the present disclosure, the stick slip detection system further includes a change amount determination unit configured to determine whether the movable portion is at the intermediate position and the control command value changes in a stepwise manner by comparing a change amount of the control command value for controlling the position of the movable portion with a predetermined change amount threshold value.

In one configuration example of the stick slip detection system according to the present disclosure, the diagnosis operation control unit stops the determination operation of the abnormality diagnosis unit when the movable portion moves to an upper limit position, when the movable portion moves to a lower limit position, when the movable portion starts moving in a direction from the upper limit position to the lower limit position, or when the movable portion starts moving in a direction from the lower limit position to the upper limit position.

In one configuration example of the stick slip detection system according to the present disclosure, the diagnosis target is a valve, the movable portion is a valve shaft, and the stick slip detection system further includes a fully open/close determination unit configured to determine, based on a control signal output to an electropneumatic converter by a positioner that controls an opening degree of the valve, whether the movable portion moves to the upper limit position, the movable portion moves to the lower limit position, the movable portion starts moving in the direction from the upper limit position to the lower limit position, or the movable portion starts moving in the direction from the lower limit position to the upper limit position.

In one configuration example of the stick slip detection system according to the present disclosure, the stick slip detection system further includes a fully open/close determination unit configured to determine, based on a control command value for controlling a position of the movable portion, whether the movable portion moves to the upper limit position, the movable portion moves to the lower limit position, the movable portion starts moving in the direction from the upper limit position to the lower limit position, or the movable portion starts moving in the direction from the lower limit position to the upper limit position.

In one configuration example of the stick slip detection system according to the present disclosure, the stick slip detection system further includes a stick slip index calculation unit configured to calculate the stick slip index.

In one configuration example of the stick slip detection system according to the present disclosure, the first state amount is an average of absolute values of first order difference value of the displacement of the movable portion, and the second state amount is a square root of a square average of the first order difference value of the displacement of the movable portion.

A stick slip detection method according to the present disclosure includes: a first step of storing a stick slip index which is a ratio of a first state amount based on a displacement of a movable portion in a diagnosis target including the movable portion having a contact sliding portion to a second state amount based on the displacement; a second step of determining whether a stick slip phenomenon occurs in the diagnosis target based on the stick slip index; and a third step of stopping a determination operation of the second step when a stepwise change in a signal for controlling a position of the movable portion is detected.

In one configuration example of the stick slip detection method according to the present disclosure, the third step includes a step of stopping the determination operation of the second step when detecting a stepwise change in a control command value for controlling the position of the movable portion at an intermediate position between an upper limit position and a lower limit position of the position of the movable portion.

In one configuration example of the stick slip detection method according to the present disclosure, the third step includes a step of determining whether the movable portion is at the intermediate position and the control command value changes in a stepwise manner by comparing a change amount of the control command value for controlling the position of the movable portion with a predetermined change amount threshold value.

In one configuration example of the stick slip detection method according to the present disclosure, the third step includes a step of stopping the determination operation of the second step when the movable portion moves to an upper limit position, when the movable portion moves to a lower limit position, when the movable portion starts moving in a direction from the upper limit position to the lower limit position, or when the movable portion starts moving in a direction from the lower limit position to the upper limit position.

In one configuration example of the stick slip detection method according to the present disclosure, the diagnosis target is a valve, the movable portion is a valve shaft, and the third step includes a step of determining, based on a control signal output to an electropneumatic converter by a positioner that controls an opening degree of the valve, whether the movable portion moves to the upper limit position, the movable portion moves to the lower limit position, the movable portion starts moving in the direction from the upper limit position to the lower limit position, or the movable portion starts moving in the direction from the lower limit position to the upper limit position.

In one configuration example of the stick slip detection method according to the present disclosure, the third step includes a step of determining, based on a control command value for controlling the position of the movable portion, whether the movable portion moves to the upper limit position, the movable portion moves to the lower limit position, the movable portion starts moving in the direction from the upper limit position to the lower limit position, or the movable portion starts moving in the direction from the lower limit position to the upper limit position.

In one configuration example of the stick slip detection method according to the present disclosure, the stick slip detection method further includes a fourth step of calculating the stick slip index.

In one configuration example of the stick slip detection method according to the present disclosure, the first state amount is an average of absolute values of first order difference value of the displacement of the movable portion, and the second state amount is a square root of a square average of the first order difference value of the displacement of the movable portion.

According to the present disclosure, the stick slip detection method can easily reflect knowledge of an expert with respect to a diagnosis target. In the present disclosure, it is possible to exclude data corresponding to aging of a diagnosis target due to long-term use, and it is possible to perform comparison and determination using the same criterion for a long period of time.

### BRIEF DESCRIPTION OF THE SEVERAL VIEWS OF THE DRAWING

FIG. 1 is a block diagram showing a configuration of a stick slip detection system according to an embodiment of the present disclosure.

FIG. 2 is a flowchart showing an operation of the stick slip detection system according to the embodiment of the present disclosure.

FIG. 3 is a flowchart showing an operation of the stick slip detection system according to the embodiment of the present disclosure.

FIG. 4 is a diagram showing an example of a control command value, a measured value of a valve opening degree, and a control signal at the time of a fully closing operation of a valve and at the opening start time from a fully closed state.

FIG. 5 is a diagram showing an example of the control command value, the measured value of the valve opening degree, and the control signal at the time of a fully opening operation of a valve and at the closing start time from a fully open state.

FIG. 6 is a diagram showing a determination operation of a change amount determination unit of the stick slip detection system according to the embodiment of the present disclosure.

FIG. 7 is a diagram showing an example in which a control command value changes in a stepwise manner at an intermediate opening degree of the valve.

FIG. 8 is a diagram showing a relationship between a change amount of a control command value and a stick slip index when the control command value changes in a stepwise manner at the intermediate opening degree of the valve.

FIG. 9 is a block diagram showing a configuration example of a computer that realizes the stick slip detection system according to the embodiment of the present disclosure.

### DETAILED DESCRIPTION OF THE INVENTION

When it is determined whether a stick slip phenomenon has occurred in a valve, a veteran maintenance person knows that an erroneous determination is often made in a case where the control command value itself greatly changes. Then, it can be confirmed from a measured value that the control command value is largely changed. The present disclosure presents a method of determining whether a stick slip phenomenon has occurred after excluding data that causes erroneous determination of the stick slip phenomenon based on information on a change amount of a control command value based on knowledge of the maintenance person.

Examples of the data with a large change amount of the control command value that may cause the erroneous determination of the stick slip phenomenon include data at the time of a fully opening operation in which the valve is operated to a fully open position, data at the time of a fully closing operation in which the valve is operated to a fully closed position, data at the closing start time from a fully open state, and data at the opening start time from a fully closed state. In these cases, since the control command value changes in a stepwise manner, a displacement of a valve shaft also changes in a stepwise manner, and a value of a stick slip index SSpv is calculated to be large. At the time of the fully opening operation, at the time of the fully closing operation, at the closing start time from the fully open state, and at the opening start time from the fully closed state, it is possible to detect these values by using a control amount that a positioner installed in the valve outputs to an electropneumatic converter. Therefore, when sections at these times are included in a calculation range of the stick slip index SSpv, the target stick slip index SSpv is excluded from stick slip determination.

Even at an intermediate opening degree, the displacement of the valve shaft changes in a stepwise manner due to the change in the control command value, and the value of the stick slip index SSpv may be calculated to be large. The stepwise change in the intermediate opening degree is detected by using the change amount of the control command value in a minute section. When a calculation section of the stick slip index SSpv includes a minute section having a change amount exceeding the set threshold value, the target stick slip index SSpv is excluded from the determination. Since the threshold value set here is a value with respect to the control command value whose change can be visually confirmed, the threshold value setting reflecting the operation state of the valve can be easily performed.

According to the above method, a method for suppressing erroneous detection of a stick slip, which can easily reflect valve knowledge, has been realized.

### [Embodiments]

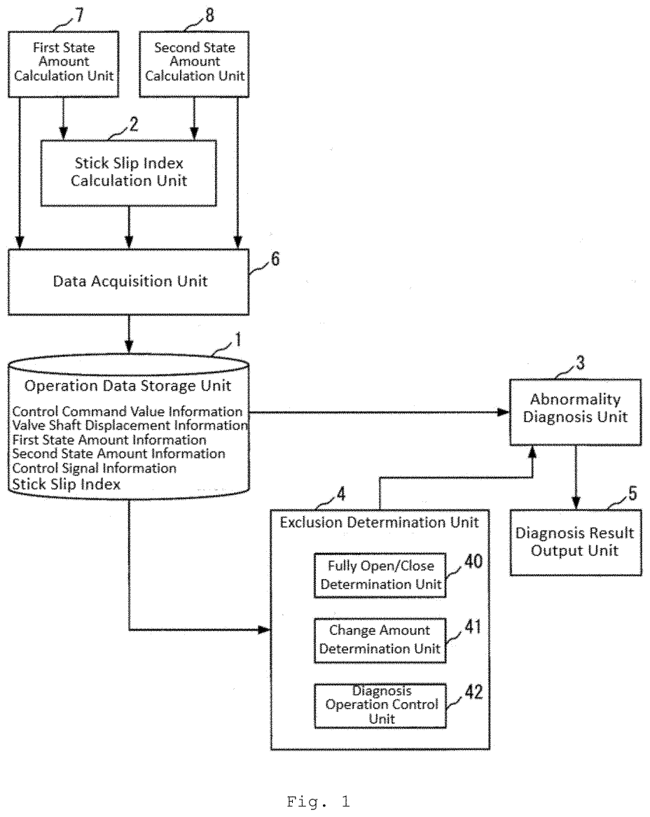

Hereinafter, an embodiment of the present disclosure will be described with reference to the drawings. FIG. 1 is a block diagram showing a configuration of a stick slip detection system according to the embodiment of the present disclosure. The stick slip detection system includes an operation data storage unit 1 that stores data of a diagnosis target (for example, a valve) including a movable portion (for example, a valve shaft) having a contact sliding portion, a stick slip index calculation unit 2 that calculates a stick slip index that is a ratio of a first state amount based on a displacement of the movable portion (valve shaft displacement) to a second state amount based on a displacement of the movable portion, an abnormality diagnosis unit 3 that determines whether a stick slip phenomenon has occurred in a diagnosis target based on the stick slip index stored in the operation data storage unit 1, an exclusion determination unit 4 that stops the determination operation of the abnormality diagnosis unit 3 when the movable portion is at an intermediate position (intermediate opening degree) between an upper limit position (fully open) and a lower limit position (fully closed) and the control command value for controlling the movable portion changes in a stepwise manner, when the movable portion moves to the upper limit position, when the movable portion moves to the lower limit position, when the movable portion starts moving in a direction from the upper limit position to the lower limit position, or when the movable portion starts moving in a direction from the lower limit position to the upper limit position, a diagnosis result output unit 5 that outputs a diagnosis result, and a data acquisition unit 6 that acquires data of the diagnosis target from an external positioner or the like.

The exclusion determination unit 4 includes a fully open/close determination unit 40, a change amount determination unit 41, and a diagnosis operation control unit 42.

Although in this embodiment, an example in which a first state amount calculation unit 7 that calculates a first state amount, a second state amount calculation unit 8 that calculates a second state amount, and a stick slip index calculation unit 2 that calculates a stick slip index are provided in a device outside the stick slip detection system (for example, a positioner that controls an opening degree of a valve to be diagnosed) will be described, the first state amount calculation unit 7, the second state amount calculation unit 8, and the stick slip index calculation unit 2 may be provided in a device in which the operation data storage unit 1, the abnormality diagnosis unit 3, the exclusion determination unit 4, and the diagnosis result output unit 5 are provided.

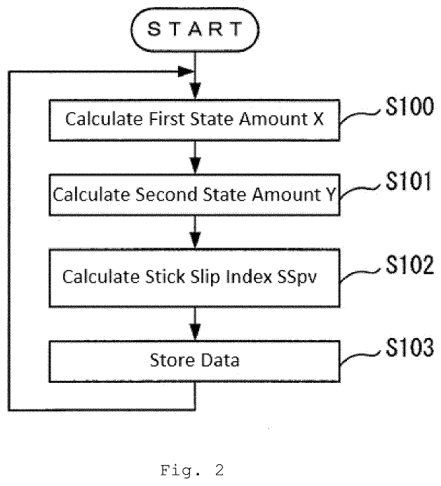

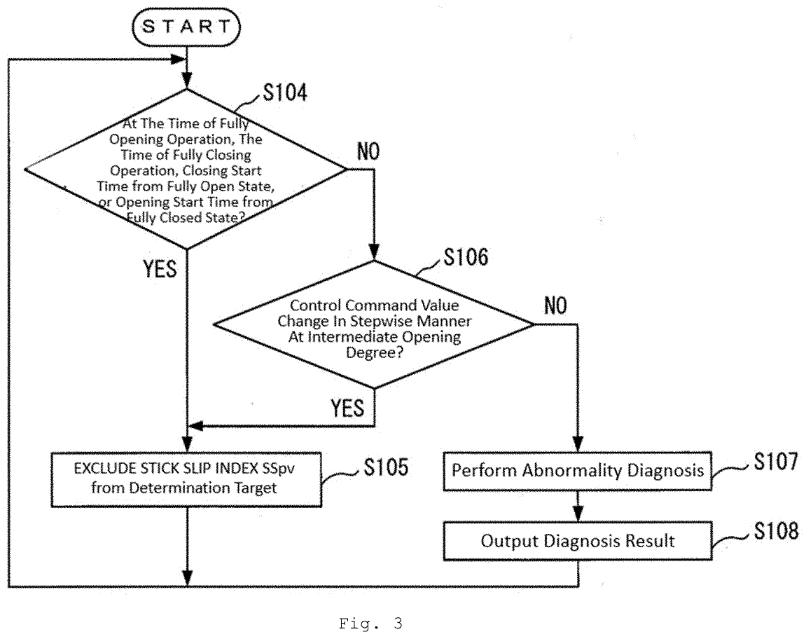

FIGS. 2 and 3 are flowcharts showing an operation of the stick slip detection system according to the embodiment.

The first state amount calculation unit 7 calculates, as the first state amount, an average X (Equation (1)) of absolute values of first order difference values of a valve shaft displacement xᵢ of the valve to be diagnosed detected by the positioner (not shown) (step S100 in FIG. 2).

The second state amount calculation unit 8 calculates, as the second state amount, a square root Y (Equation (2)) of a square average of the first order difference value of the valve shaft displacement xᵢ (step S101 in FIG. 2).

The first state amount calculation unit 7 and the second state amount calculation unit 8 calculate the first state amount X and the second state amount Y for each sampling of the valve shaft displacement xᵢ.

The stick slip index calculation unit 2 calculates the stick slip index SSpv by dividing the second state amount Y by the first state amount X of the same time as the second state amount Y (step S102 in FIG. 2). The stick slip index calculation unit 2 performs such calculation for each sampling of the first state amount X and the second state amount Y.

SSpv=Y/X (5)

The data acquisition unit 6 acquires time-series data of the first state amount X, the second state amount Y, the stick slip index SSpv, the control command value (set opening degree) SP of the valve opening degree given to the positioner, the valve shaft displacement xᵢ detected by the positioner, and a control signal MV (EPM drive signal) output to an electropneumatic converter by the positioner, and stores the time-series data in the operation data storage unit 1 (step S103 in FIG. 2). As is well known, the positioner outputs the control signal MV corresponding to the control command value SP to the electropneumatic converter, the electropneumatic converter converts the control signal MV into air pressure and outputs the air pressure to an operating device, and the operating device drives the valve. Time information is added to each data of the first state amount X, the second state amount Y, the control command value SP, the valve shaft displacement xᵢ, and the control signal MV. The time information may be added on the positioner side, or may be added by the data acquisition unit 6.

On the other hand, the fully open/close determination unit 40 of the exclusion determination unit 4 determines, based on data stored in the operation data storage unit 1, whether the valve to be diagnosed is at any one of the time of the fully opening operation in which the valve to be diagnosed is operated to the fully open position, the time of the fully closing operation in which the valve to be diagnosed is operated to the fully closed position, the closing start time from the fully open state, and the opening start time from the fully closed state (step S104 in FIG. 3). Whether the valve to be diagnosed is at the time of the fully opening operation, at the time of the fully closing operation, at the closing start time from the fully open state, or at the opening start time from the fully closed state can be determined based on the control signal MV that the positioner outputs to the electropneumatic converter. When the valve is in the fully open state or the fully closed state, the control signal MV has a value that is shifted to 100% or more or 0% or less. The control signal MV has a value in the vicinity of 50% when the valve is at the intermediate opening degree. The fully open/close determination unit 40 performs the determination described above for each sampling of the control signal MV.

When the fully open/close determination unit 40 determines that the valve to be diagnosed is at any one of the time of the fully opening operation, the time of the fully closing operation, the closing start time from the fully open state, and the opening start time from the fully closed state (YES in step S104), the diagnosis operation control unit 42 of the exclusion determination unit 4 instructs the abnormality diagnosis unit 3 not to perform a determination using the stick slip index SSpv including a time range of any one of the states in the calculation range. In response to the instruction from the diagnosis operation control unit 42, the abnormality diagnosis unit 3 does not perform the determination to be described later (step S105 in FIG. 3).

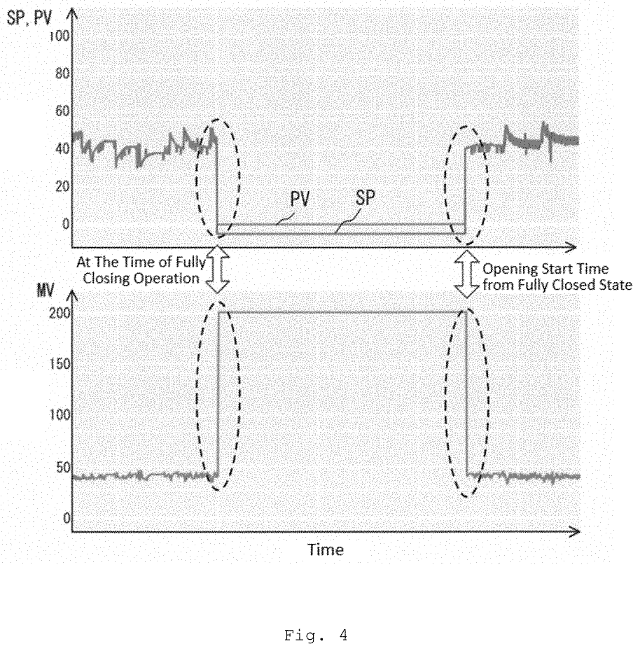

FIG. 4 is a set of diagrams showing an example of the control command value SP, the measured value PV of the valve opening degree, and the control signal MV at the time of the fully closing operation of the valve and at the opening start time from the fully closed state. FIG. 5 is a set of diagrams showing an example of the control command value SP, the measured value PV of the valve opening degree, and the control signal MV at the time of the fully opening operation of the valve and at the closing start time from the fully open state.

On the other hand, when the fully open/close determination unit 40 determines that the valve to be diagnosed is not at any one of the time of the fully opening operation, the time of the fully closing operation, the closing start time from the fully open state, and the opening start time from the fully closed state (NO in step S104), the change amount determination unit 41 of the exclusion determination unit 4 determines whether the control command value SP changes in a stepwise manner at the intermediate opening degree of the valve to be diagnosed (step S106 in FIG. 3). The intermediate opening degree refers to all degrees of opening other than the fully open state and the fully closed state. Whether the control command value SP changes in a stepwise manner at the intermediate opening degree can be determined by whether the change amount of the control command value SP per certain time (certain number of samplings) exceeds a predetermined change amount threshold value.

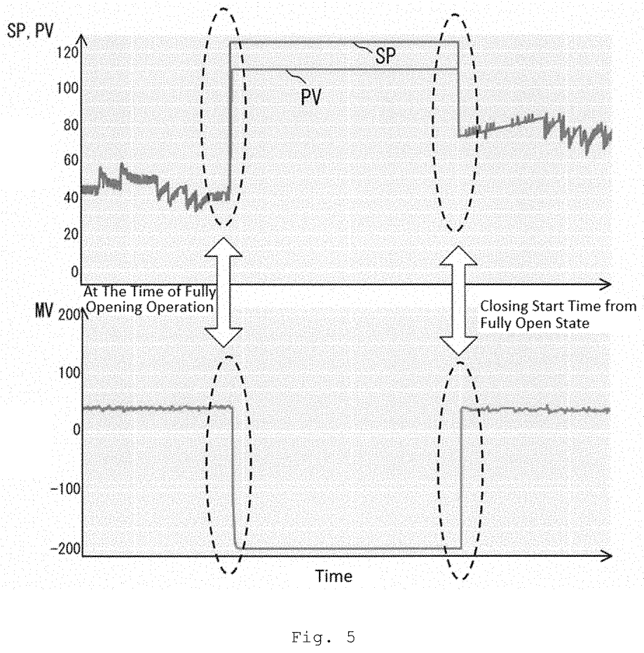

FIG. 6 is a diagram showing a determination operation of the change amount determination unit 41. The change amount determination unit 41 extracts a section having a constant number of samplings of continuous data of the control command value SP, and calculates a change amount of the control command value SP in the section. In the present embodiment, a section width is set to 5 samples, and the change amount threshold value is set to 10. A difference between the maximum value and the minimum value of the control command value SP in the section having the constant number of samplings is set as the change amount of the section. Although in the present embodiment, the section width is set to 5 samples and the change amount threshold value is set to 10, these are examples, and it is needless to say that other values may be adopted.

In the example of FIG. 6, a change amount of the control command value SP in the sections t1 and t2 is smaller than the change amount threshold value (=10). On the other hand, in the section t3, since the difference between the maximum value SPmax and the minimum value SPmin of the control command value SP becomes larger than the change amount threshold value, the change amount determination unit 41 determines that the control command value SP changes in a stepwise manner. The change amount determination unit 41 performs the determination described above for each sampling of the control command value SP.

Although the change amount of the control command value SP is defined by the above contents, a calculation of the change amount may be performed by another calculation method (for example, a sum obtained by adding a difference of the control command value SP for each sample over five samples).

Since the change amount threshold value is a value with respect to the control command value SP in which the change can be visually confirmed, the setting reflecting the operation state of the valve can be easily performed as compared with the setting parameters α and β of the related art.

When the change amount determination unit 41 determines that the control command value SP changes in a stepwise manner at the intermediate opening degree of the valve to be diagnosed (YES in step S106), the diagnosis operation control unit 42 of the exclusion determination unit 4 instructs the abnormality diagnosis unit 3 not to perform the determination using the stick slip index SSpv including the time range of this state in the calculation range. In response to the instruction from the diagnosis operation control unit 42, the abnormality diagnosis unit 3 does not perform the determination to be described later (step S105 in FIG. 3).

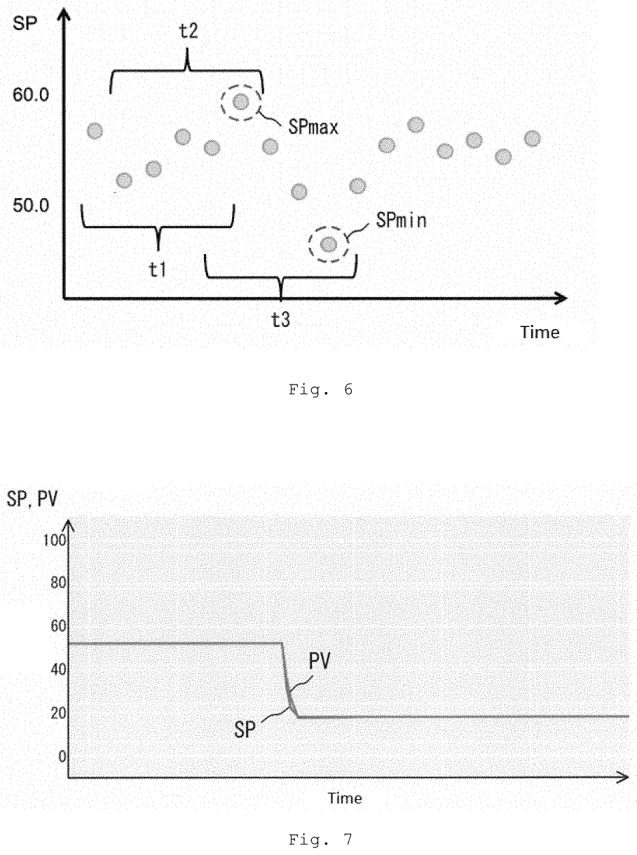

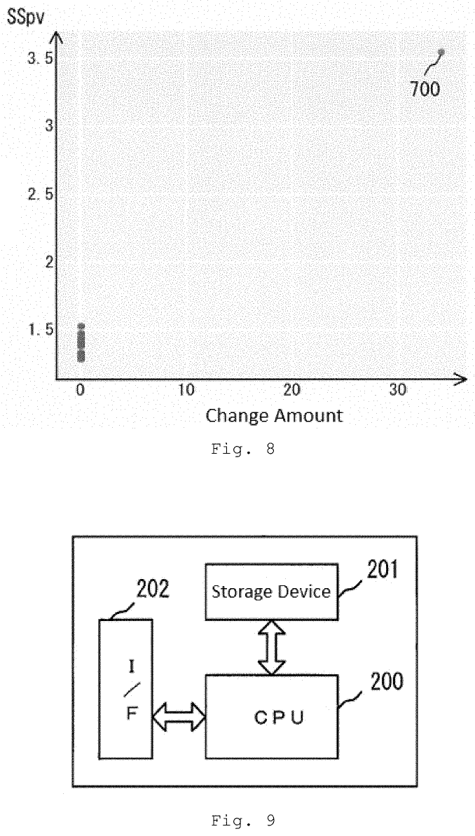

FIG. 7 is a diagram showing an example in which the control command value SP changes in a stepwise manner at the intermediate opening degree of the valve. FIG. 8 is a diagram showing a relationship between the change amount of the control command value SP and the stick slip index SSpv when the control command value SP changes in a stepwise manner as in the section shown in FIG. 7. A point 700 in FIG. 8 is a value corresponding to the section shown in FIG. 7.

Next, the abnormality diagnosis unit 3 compares the stick slip index SSpv calculated by the stick slip index calculation unit 2 with a predetermined index threshold value Th to perform abnormality diagnosis of the valve to be diagnosed (step S107 in FIG. 3). When the stick slip index SSpv is greater than the index threshold value Th, the abnormality diagnosis unit 3 determines that a stick slip phenomenon has occurred in the valve to be diagnosed, and when the stick slip index SSpv is equal to or less than the index threshold value Th, the abnormality diagnosis unit 3 determines that a stick slip phenomenon has not occurred in the valve to be diagnosed. The abnormality diagnosis unit 3 performs such a determination for each sampling of the stick slip index SSpv.

Although in the present embodiment, the abnormality diagnosis unit 3 compares the stick slip index SSpv with the index threshold value Th to perform abnormality diagnosis of the valve to be diagnosed, the present disclosure is not limit thereto. Another index may be calculated from the stick slip index SSpv, and the abnormality diagnosis of the valve may be performed based on this another index.

The diagnosis result output unit 5 outputs the diagnosis result of the abnormality diagnosis unit 3 (step S108 in FIG. 3). As an output method, there is display of the diagnosis result, transmission of information indicating the diagnosis result to the outside, or the like.

As described above, the abnormality diagnosis unit 3 stops the determination operation when there is an instruction from the diagnosis operation control unit 42 of the exclusion determination unit 4. The abnormality diagnosis unit 3 stops the determination operation in response to an instruction from the diagnosis operation control unit 42 when the times (calculation range of the stick slip index SSpv) of N valve shaft displacements xᵢ used for the calculations of the first state amount X and the second state amount Y, which are the bases of the stick slip index SSpv, include at least a part of a time which is any one of the time of the fully opening operation of the valve, the time of the fully closing operation, the closing start time from the fully open state, and the opening start time from the fully closed state. Similarly, the abnormality diagnosis unit 3 stops the determination operation in response to an instruction from the diagnosis operation control unit 42 when at least a part of the time of a section in which the change amount of the control command value SP exceeds the change amount threshold value is included in the calculation range of the stick slip index SSpv.

In this way, in the present embodiment, it is possible to easily reflect the knowledge of the expert of the valve in the stick slip detection method. In the present embodiment, since the index threshold value and the change amount threshold value can be flexibly changed, it is possible to exclude data corresponding to aging due to long-term valve use, and it is possible to perform comparison and determination using the same criterion for a long period of time.

The fully open/close determination unit 40 may determine whether the valve to be diagnosed is at any one of the time of the fully opening operation, the time of the fully closing operation, the closing start time from the fully open state, and the opening start time from the fully closed state based on the control command value SP.

The operation data storage unit 1, the abnormality diagnosis unit 3, the exclusion determination unit 4, the diagnosis result output unit 5, and the data acquisition unit 6 described in the present embodiment can be implemented by a computer including a central processing unit (CPU), a storage device, and an interface, and a program for controlling these hardware resources. A configuration example of the computer is shown in FIG. 9.

The computer includes a CPU 200, a storage device 201, and an interface device (I/F) 202. The I/F 202 is connected to hardware of the diagnosis result output unit 5, a positioner, and the like. A program for implementing a stick slip detection method of the present disclosure is stored in the storage device 201. The CPU 200 executes the processing described in the present embodiment in accordance with a program stored in the storage device 201.

As described above, the first state amount calculation unit 7, the second state amount calculation unit 8, and the stick slip index calculation unit 2 may be implemented by the same computer as the operation data storage unit 1, the abnormality diagnosis unit 3, the exclusion determination unit 4, the diagnosis result output unit 5, and the data acquisition unit 6, or may be implemented by another computer (for example, a microcomputer of a positioner).

The present disclosure can be applied to a technique for detecting stick slip of a valve.

### DESCRIPTION OF REFERENCE NUMERALS AND SIGNS

1 operation data storage unit, 2 stick slip index calculation unit, 3 abnormality diagnosis unit, 4 exclusion determination unit, 5 diagnosis result output unit, 6 data acquisition unit, 7 first state amount calculation unit, 8 second state amount calculation unit, 40 fully open/close determination unit, 41 change amount determination unit, 42 diagnosis operation control unit

1. A stick slip detection system, comprising:
a storage unit configured to store a stick slip index, the stick slip index being a ratio of a first state amount based on a displacement of a movable portion in a diagnosis target including the movable portion having a contact sliding portion to a second state amount based on the displacement;
an abnormality diagnosis unit configured to determine whether a stick slip phenomenon occurs in the diagnosis target based on the stick slip index; and
a diagnosis operation control unit configured to, when a stepwise change in a signal for controlling a position of the movable portion is detected, stop a determination operation of the abnormality diagnosis unit.

2. The stick slip detection system according to claim 1, wherein
the diagnosis operation control unit stops the determination operation of the abnormality diagnosis unit when detecting a stepwise change in a control command value for controlling the position of the movable portion at an intermediate position between an upper limit position and a lower limit position of the position of the movable portion.

3. The stick slip detection system according to claim 2, further comprising:
a change amount determination unit configured to determine whether the movable portion is at the intermediate position and the control command value changes in a stepwise manner by comparing a change amount of the control command value with a predetermined change amount threshold value.

4. The stick slip detection system according to claim 1, wherein
the diagnosis operation control unit stops the determination operation of the abnormality diagnosis unit when the movable portion moves to an upper limit position, when the movable portion moves to a lower limit position, when the movable portion starts moving in a direction from the upper limit position to the lower limit position, or when the movable portion starts moving in a direction from the lower limit position to the upper limit position.

5. The stick slip detection system according to claim 4, wherein
the diagnosis target is a valve, and the movable portion is a valve shaft, and
the stick slip detection system further comprises a fully open/close determination unit configured to determine, based on a control signal output to an electropneumatic converter by a positioner that controls an opening degree of the valve, whether the movable portion moves to the upper limit position, the movable portion moves to the lower limit position, the movable portion starts moving in the direction from the upper limit position to the lower limit position, or the movable portion starts moving in the direction from the lower limit position to the upper limit position.

6. The stick slip detection system according to claim 4, further comprising:
a fully open/close determination unit configured to determine, based on a control command value for controlling the position of the movable portion, whether the movable portion moves to the upper limit position, the movable portion moves to the lower limit position, the movable portion starts moving in the direction from the upper limit position to the lower limit position, or the movable portion starts moving in the direction from the lower limit position to the upper limit position.

7. The stick slip detection system according to claim 1, further comprising:
a stick slip index calculation unit configured to calculate the stick slip index.

8. The stick slip detection system according to claim 2, further comprising:
a stick slip index calculation unit configured to calculate the stick slip index.

9. The stick slip detection system according to claim 4, further comprising:
a stick slip index calculation unit configured to calculate the stick slip index.

10. The stick slip detection system according to claim 1, wherein
the first state amount is an average of absolute values of first order difference value of the displacement of the movable portion, and
the second state amount is a square root of a square average of the first order difference value of the displacement of the movable portion.

11. The stick slip detection system according to claim 2, wherein
the first state amount is an average of absolute values of first order difference value of the displacement of the movable portion, and
the second state amount is a square root of a square average of the first order difference value of the displacement of the movable portion.

12. The stick slip detection system according to claim 4, wherein
the first state amount is an average of absolute values of first order difference value of the displacement of the movable portion, and
the second state amount is a square root of a square average of the first order difference value of the displacement of the movable portion.

13. A stick slip detection method, comprising:
a first step of storing a stick slip index which is a ratio of a first state amount based on a displacement of a movable portion in a diagnosis target including the movable portion having a contact sliding portion to a second state amount based on the displacement;
a second step of determining whether a stick slip phenomenon occurs in the diagnosis target based on the stick slip index; and
a third step of stopping a determination operation of the second step when a stepwise change in a signal for controlling a position of the movable portion is detected.

14. The stick slip detection method according to claim 13, wherein
the third step includes a step of stopping the determination operation of the second step when detecting a stepwise change in a control command value for controlling the position of the movable portion at an intermediate position between an upper limit position and a lower limit position of the position of the movable portion.

15. The stick slip detection method according to claim 14, wherein
the third step includes a step of determining whether the movable portion is at the intermediate position and the control command value changes in a stepwise manner by comparing a change amount of the control command value with a predetermined change amount threshold value.

16. The stick slip detection method according to claim 13, wherein
the third step includes a step of stopping the determination operation of the second step when the movable portion moves to an upper limit position, when the movable portion moves to a lower limit position, when the movable portion starts moving in a direction from the upper limit position to the lower limit position, or when the movable portion starts moving in a direction from the lower limit position to the upper limit position.

17. The stick slip detection method according to claim 16, wherein
the diagnosis target is a valve, and the movable portion is a valve shaft, and
the third step includes a step of determining, based on a control signal output to an electropneumatic converter by a positioner that controls an opening degree of the valve, whether the movable portion moves to the upper limit position, the movable portion moves to the lower limit position, the movable portion starts moving in the direction from the upper limit position to the lower limit position, or the movable portion starts moving in the direction from the lower limit position to the upper limit position.

18. The stick slip detection method according to claim 16, wherein
the third step includes a step of determining, based on a control command value for controlling the position of the movable portion, whether the movable portion moves to the upper limit position, the movable portion moves to the lower limit position, the movable portion starts moving in the direction from the upper limit position to the lower limit position, or the movable portion starts moving in the direction from the lower limit position to the upper limit position.

19. The stick slip detection method according to claim 13, further comprising:
a fourth step of calculating the stick slip index.

20. The stick slip detection method according to claim 13, wherein
the first state amount is an average of absolute values of first order difference value of the displacement of the movable portion, and
the second state amount is a square root of a square average of the first order difference value of the displacement of the movable portion.
